(19) United States
(12) Patent Application Publication
(10) Pub. No.: US 2017/0126488 A1
(43) Pub. Date: May 4, 2017

(54) USE OF MOTION LANGUAGE FOR NETWORK COMMANDS IN 60GHZ NETWORKS

(71) Applicants: Carlos Cordeiro, Portland, OR (US); Guoqing Li, Portland, OR (US); Ali S. Sadri, San Diego, CA (US); Bahareh B. Sadeghi, Portland, OR (US)

(72) Inventors: Carlos Cordeiro, Portland, OR (US); Guoqing Li, Portland, OR (US); Ali S. Sadri, San Diego, CA (US); Bahareh B. Sadeghi, Portland, OR (US)

(21) Appl. No.: 13/996,650

(22) PCT Filed: Dec. 16, 2011
(86) PCT No.: PCT/US2011/065374

§ 371 Date: Apr. 17, 2014

(51) Int. Cl. H04L 12/24; H04W 64/00; G06F 3/01

(52) U.S. Cl. CPC H04L 41/0803; G06F 3/017; H04W 64/006; H04W 84/18

(57) ABSTRACT

A network device includes a motion command database maintaining a plurality of tractable movements, each tractable movement is defined by a motion of the network device with respect to a first position. The movement comprises a plurality of commands and at least one target device selection. The network device includes a mapping table comprising a plurality of command maps, each of the command maps corresponding to at least one particular network role and mapping at least one of the movements to a command for controlling the role of a target device. The network device uses beamforming information to identify the target device for communication and motion language via a motion detection sensor operable to detect motion of the network device within three dimensions to detect the commands for assigning network roles.

### BACKGROUND

1. Field of the Disclosed Embodiments

The present invention relates generally to network devices and, more particularly, to network devices with a motion interface to assign network roles in a wireless network.

2. Introduction

Although not limited in this respect, wireless fidelity (Wi-Fi) Peer-to-Peer networking, Wi-Fi PAN and Mesh are emerging as important extensions to the Institute for Electronic and Electrical Engineers (IEEE) 802.11 standard for wireless networking. These types of networks have one important difference compared to an infrastructure-based (BSS) WLAN network; they are very mobile, can be created anywhere on the fly and can be very volatile (peers coming and leaving). With these kinds of ad hoc networks, one wireless peer is usually acting as the Master while the other peers are acting as Slave devices. In a Wi-Fi PAN network e.g. the Master will be a device that acts as an Access Point (software-based AP or SoftAP) and the Slaves will be regular stations (STAs).

When a wireless device supports both the access point (AP) and wireless station (STA) functionality, it could change modes on a need basis. If it is the first device in the personal area network (PAN) establishment, it will act as an AP—if it is joining an already existing PAN it will act as a STA. In effect, you will have one AP (Master) and one or more STAs (Slaves) in a Wi-Fi PAN. The problem starts when the AP (Master) wants to leave the PAN. When the AP leaves the PAN formation, the PAN will stop to exist unless one of the peers (Slaves) can switch over to AP mode and become the Master device of this PAN.

Network roles in wireless networks, for example the role of a central coordinator in a centralized MAC, are traditionally either hardwired in the devices or decided by the devices with no direct input from or interaction with the user. This may potentially result in suboptimal performance in a mobile and dynamic environment, due to the fact that different network roles utilize different resources on the device. For example, the central coordinator would utilize more power due to restrictions for transitioning to power save mode and its increased amount of communications. While handover on the role of central controller in 60 GHz MAC are allowed, for example when the device is not powered and running out of battery, there is no mechanism to allow input from the user to add flexibility to switch roles based on the information that the user has. For example in a personal area network composed of multiple portable devices, user's phone might assume the role of coordinator, while the user needs to preserve the phone battery due to its mobility during the day. In such a situation with current solutions, the user would have no way of impacting the network settings when it comes to the roles the devices assume.

### DETAILED DESCRIPTION OF THE DISCLOSED EMBODIMENTS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

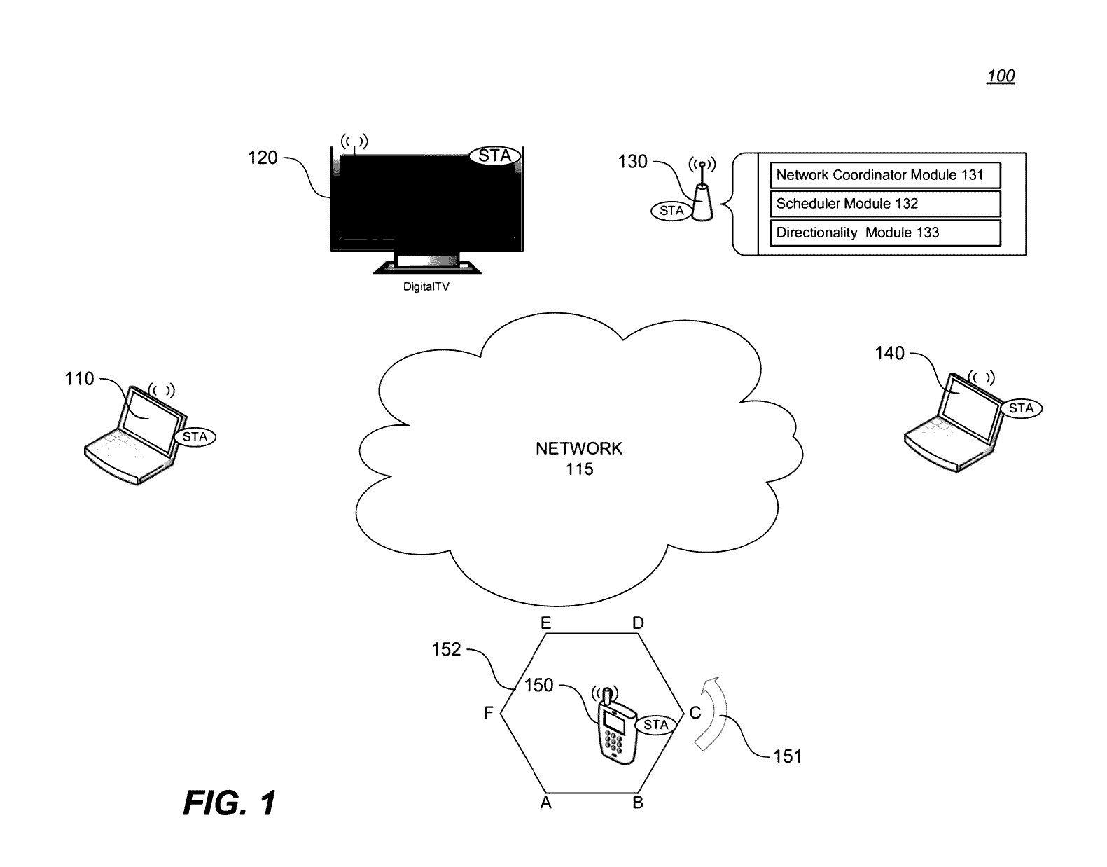

FIG. 1 illustrates dynamic switching of network roles in a wireless PAN of an embodiment of the invention;

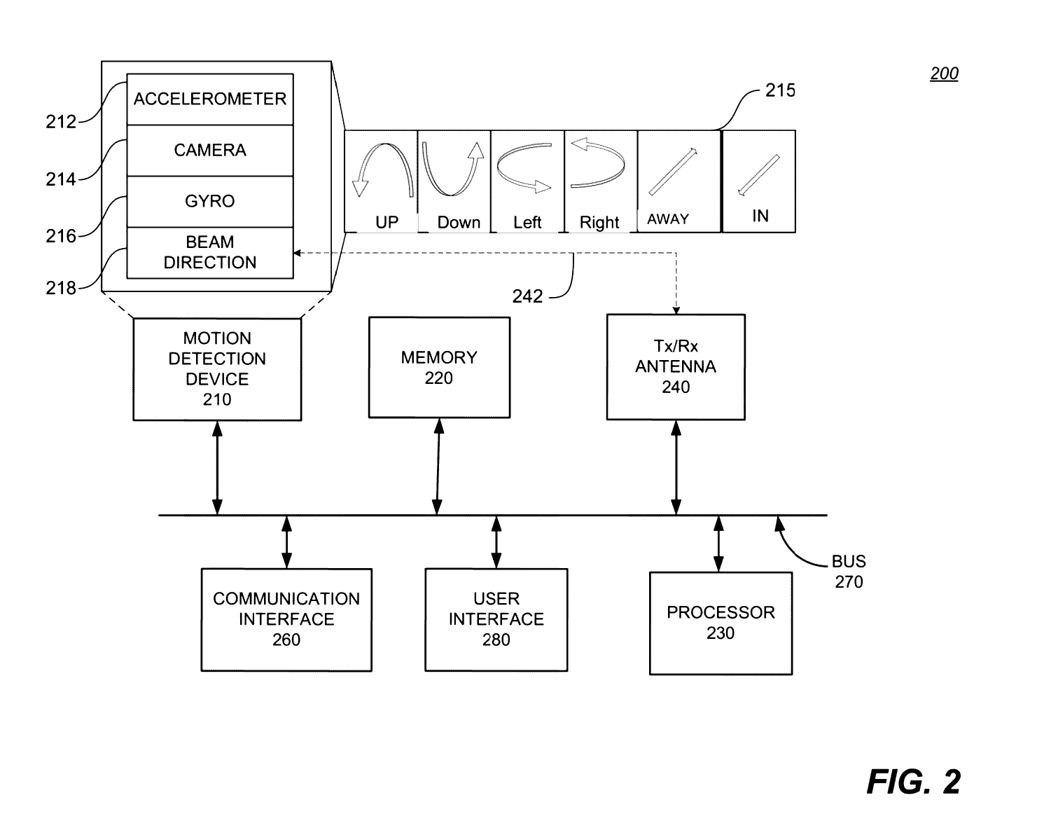

FIG. 2 is an exemplary diagram that illustrates a network device with motion based input to command the network device to dynamically assign network roles in accordance with a possible embodiment of the invention;

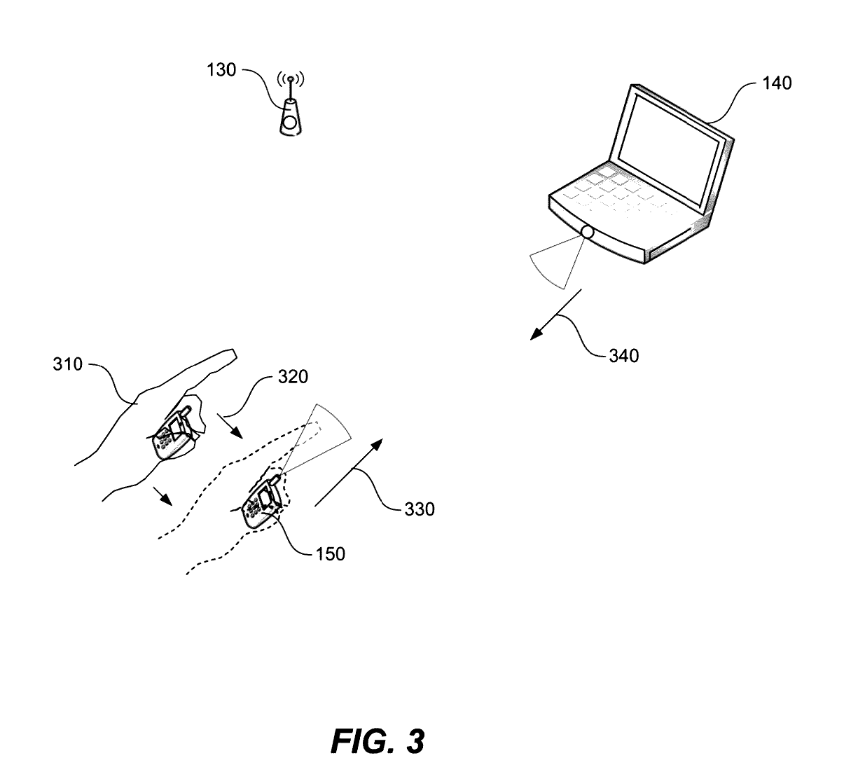

FIG. 3 is an illustration of a motion command and response messages to communicate the user's intention over 60 GHz link to the target device in accordance with one possible embodiment of the invention;

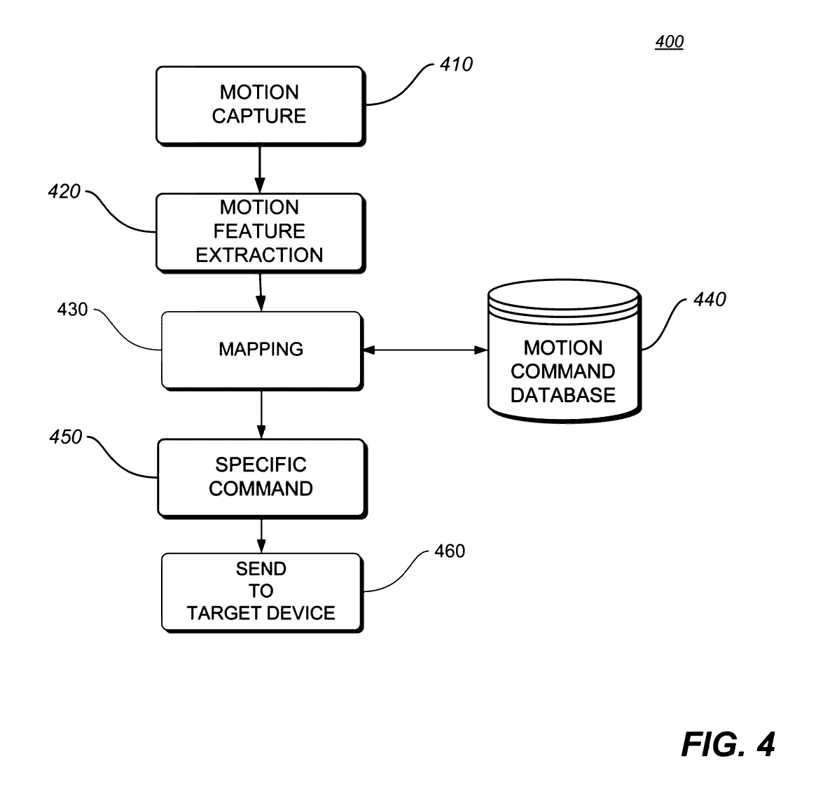

FIG. 4 is a flowchart illustrating a process for generating a command from motion capture in accordance to an embodiment;

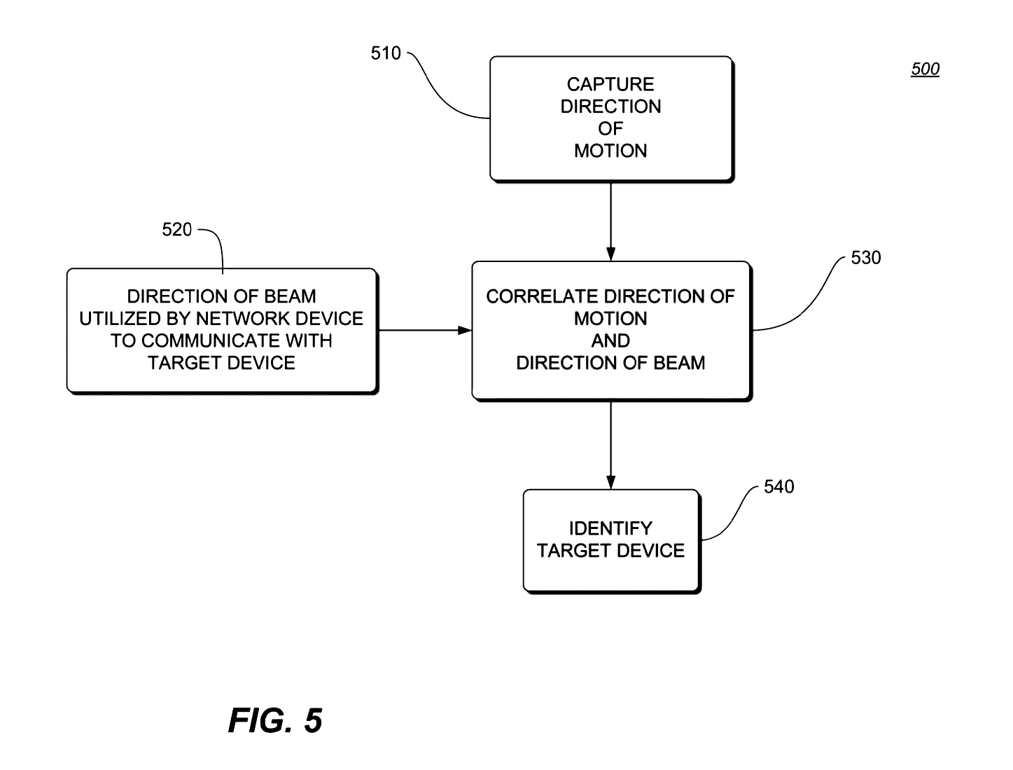

FIG. 5 is a flowchart illustrating the identification of a target device from the direction of motion and the direction of beam in accordance to an embodiment; and

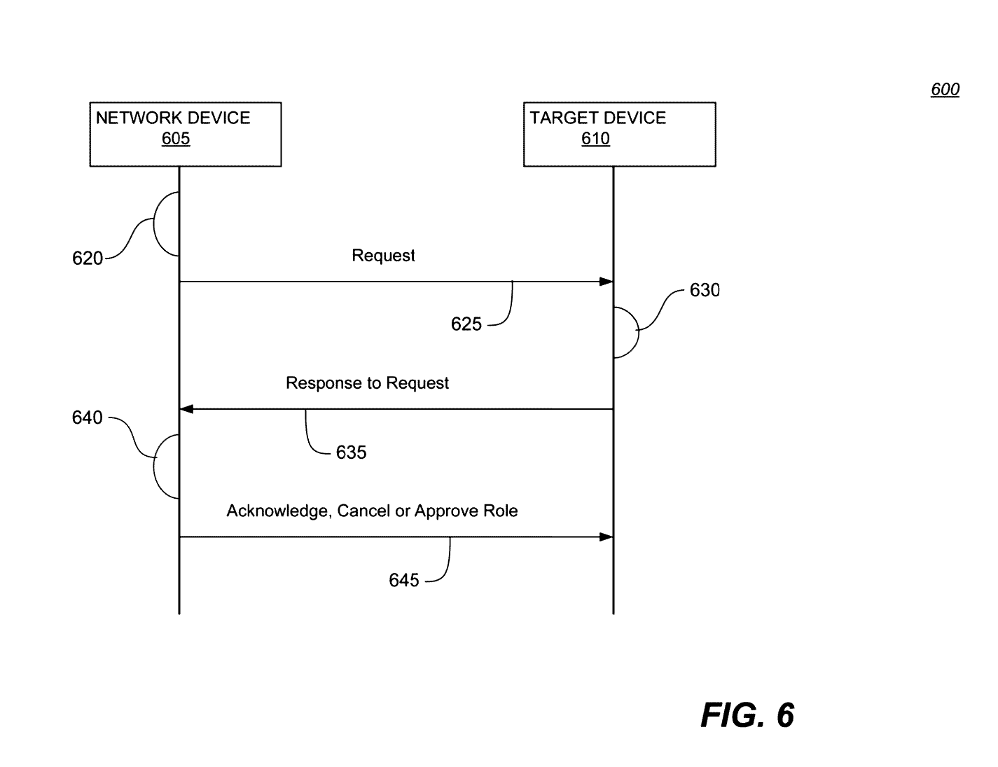

FIG. 6 is a process diagram illustrating how a command to dynamically assign network roles in a wireless network is communicated to a network device in accordance to an embodiment.

Additional features and advantages of the disclosure will be set forth in the description which follows, and in part will be obvious from the description, or may be learned by practice of the disclosure. The features and advantages of the disclosure may be realized and obtained by means of the instruments and combinations particularly pointed out in the appended claims. These and other features of the present disclosure will become more fully apparent from the following description and appended claims, or may be learned by the practice of the disclosure as set forth herein.

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Although embodiments of the invention are not limited in this regard, discussions utilizing terms such as, for example, “processing,” “computing,” “calculating,” “determining,” “applying,” “receiving,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. For example, “a plurality of resistors” may include two or more resistors.

Embodiments of the present invention provide a virtual basic service set (BSS) method to assign roles or assign functionalities with the same BSSID to a peer device. The present invention proposes a mechanism for the user to dynamically assign network roles to the devices by use of motion language. Motion is an effective way of identifying target devices for communication due to the directional nature of communication in 60 GHz networks. In a possible embodiment the virtual BSS method accelerates the master handover process by using a mechanism to allow input from the user to add flexibility to switch roles based on the information that the user has. A mechanism of the present invention allows seamless handovers between masters in a wireless PAN-type network without requiring any changes at the non-master capable client side.

FIG. 1 illustrates dynamic switching of network roles in a wireless personal area network (PAN) of an embodiment of the invention. A Personal Basic Service Set (PBSS) can be used to support mmWave usages. The PBSS can include a STA configured to operate as a network coordinator or a PCP (PBSS central point) 130 which can facilitate directionality in mmWave or higher frequencies networks 115, such as networks like 60 GHz/802.11ad network entities, i.e., PBSS (Personal) and PCP (PBSS central point) operating at or near 60 GHz. In some aspects, PCP 130 can be replaced with an AP. The PCP can schedule communication amongst network STAs 110, 120, 140, and 150. Network STAs 110, 120, 140, and 150 can be configured as APs or as non-APs STAs such as devices operating on the network that are enabled to be synchronized by the network and used elsewhere, for example mobile communication devices including wireless displays or phones. FIG. 1 is merely an example architecture having four network STAs; however, two or more devices may create a network without any of them being connected to a network; they can for example share files, and the like.

FIG. 1 shows an example network coordinator or PCP or AP (device 130) in accordance with various aspects of the present disclosure. The example network coordinator or PCP or AP is shown having a network coordinator module 131, a scheduler module 132 and a directionality module 133. The network coordinator module can be configured to coordinate operation in one or more wireless network architecture modes. For example, the wireless network modes can include infrastructure BSS, IBSS or PBSS. The network coordinator module can also be configured to communicate to a network station or STAs which mode of the one or more wireless network architecture modes is active for communication. The network stations can be a wireless device that is arranged to operate in the infrastructure mode and enable connection with a wireless access point. The network coordinator module can also include a scheduler module that is configured to schedule communication to the network station. The network coordinator module can also include a directionality module that is configured to directionally operate in a high-frequency or millimeter wave band, such as 60 GHz network architecture.

FIG. 1 illustrates dynamic switching of network roles to assign PBSS central point functionality to a station acting as a slave with PCP 130 This capability provides session continuity in an ad hoc type network (master-slave type network) when the PBSS central point device such as PCP 130 has to leave the network or may not be able to perform its function due to changes in requirements. The acting PCP 130 knows or can request the peers' capabilities and assign one of the other peers (slaves) 110, 150 and 140 to assume the PCP role such as STA 110 with the same PBSS ID. The proposed mechanism allows seamless handovers in a wireless PAN-type network without requiring any change at the client side. Further, an embodiment of the present invention allows a STA device to take over the role of PBSS central point if the original PCP needs to leave the network or allow a user to switch roles based on the information that the user has. For example, a user of a handheld device such as mobile device 150 can motion a role such as by turning or twirling 151 the device and to select a target device based on the direction of either the motion or the sector where the device is stopped such as positions 152 on the hexagon.

FIG. 2 is an exemplary diagram that illustrates a network device 200 with motion based input to command the network device to dynamically assign network roles in accordance with a possible embodiment of the invention. The description of FIG. 2 provides an overview of computer hardware and a suitable computing environment in conjunction with which some embodiments can be implemented. Embodiments are described in terms of a computer executing computer-executable instructions. However, some embodiments can be implemented entirely in computer hardware in which the computer-executable instructions are implemented in read-only memory. Some embodiments can also be implemented in client/server computing environments where remote devices that perform tasks are linked through a communications network. Program modules can be located in both local and remote memory storage devices in a distributed computing environment. The network device 120 may include a bus 270, a processor 230, a memory 220, a Tx/Rx antenna 240, a communication interface 260, a motion detection device 210, and a user interface 280. Bus 270 may permit communication among the components of the network device 120.

Motion detection device 210 can comprise one or more accelerometer 212, gyro 216, inclinometers, camera 214, tilt sensors, beam direction 218, or any other sensors that can determine the motion of a device within N degrees of freedom, with N being an integer greater than or equal to one. The network device will be subjected to movements that will cause it to roll, pitch, and yaw like an airplane in flight. For example, in six degrees of freedom one can use six vectors in the spatial domain over the smoothed curve points: (1) x horizontal coordinates; (2) y vertical coordinates; (3) S path distance from the origin; (4) theta angle of the path tangent at the point with the x-axis; (5) c curvature; (6) Delta_c derivative of curvature along a respective axis such as x, y, or z In the temporal domain vectors calculated from the original motion data points such as horizontal velocity, vertical velocity, tangential velocity, tangential acceleration, and angular velocity can be used for motion detection. Accelerometers detect movement of the device by detecting acceleration along a respective sensing axis such as x, y, and z. A movement pattern may comprise a series, sequence, or pattern of accelerations detected by the accelerometers. When the handheld device is tilted along a sensing axis of a particular accelerometer, the gravitational acceleration along the sensing axis changes. This change in gravitational acceleration is detected by the accelerometer and reflects the tilt of the device. Similarly, translation of the network device, or movement of the device without rotation or tilt also produces a change in acceleration along a sensing axis which is also detected by the accelerometers. Accelerometers, gyros, or tilt sensors can be used to measure translation or tilting of the device within a given coordinate structure. The output of the motion detection device 210 can be processed by processor 230 with instructions in memory 220 to extract features from the movement of the network device to verify both the command and the target device that is to be assigned a role.

Processor 230 may include at least one conventional processor or microprocessor that interprets and executes instructions. Memory 220 may be a random access memory (RAM) or another type of dynamic storage device that stores information and instructions for execution by processor 230. Memory 220 may also include a read-only memory (ROM) which may include a conventional ROM device or another type of static storage device that stores static information and instructions for processor 230. Tx/Rx antenna 240 may include one or more transmitters and receivers. The transceiver (Tx/RX) may include sufficient functionality to interface with any network or communications station and may be defined by hardware or software in any manner known to one of skill in the art. The processor 230 is cooperatively operable with the transceiver to support operations within the communications network 110. The transceiver transmits and receives transmissions via one or more antennae in a manner known to those of skill in the art.

Communication interface 260 may include any mechanism that facilitates communication via network such as network 115. Alternatively, communication interface 260 may include other mechanisms for assisting the Tx/RX antenna 240 in communicating with other devices or systems via wireless connections. User interface 280 may include one or more conventional input mechanisms that permit a user to input information, communicate with the network device 200, and present information to the user, such as an electronic display, microphone, touchpad, keypad, keyboard, mouse, pen, stylus, voice recognition device, buttons, one or more speakers.

The network device 200 may perform with processor 230 input, output, communication, programmed, and user command functions by executing sequences of instructions contained in a computer-readable medium, such as, for example, memory 220. Such sequences of instructions may be read into memory 220 from another computer-readable medium, such as a storage device, or from a separate device via communication interface 260.

The user uses the network device 200 such as a mobile device (smartphone, notebook pc, and the like) to make movements according to a predefined motion language. The motion language has two components (a) movement to identify the command, (b) movement to identify the target device from movement in the direction of the nominated device, or (c) a single movement that identifies both the command and the target device. Illustrated in 215 are examples of movements which may be utilized to perform various functions, such as functions enabling a user to command the network device 200 to assign roles. The illustrated example include an “up” movement to navigate in an upward direction, a “down” movement to navigate down, a “left” movement to navigate left, a “right” movement to navigate right, an “in” movement to navigate in a direction towards the user and an “out” movement to navigate away from the user. It should be understood that these are mere example movements and other embodiments may include different movement or similar movements to target devices and commands.

The network device 200 translates the motions like movements 215 into two pieces of information. The first information is the specific command to be communicated with the target device (for example, the role of the target device). The motion to command is accomplished by mapping the user's movements to possible command a priori. The second information is the identification of the target device. This is done by correlating the direction of motion with the direction of the beam (e.g., beam direction 218) the network device utilizes for communication with the devices in the network such as an ad hoc type network. Correlation of beam and motion is specifically useful in scenarios where devices are in line of sight of one another and hence the beam is most probably directly in the direction of the device and there is no ambiguity in identifying a device in the direction of motion. Beam direction 218 module is capable of identifying potential target emitter devices such as laptop and wireless access point, and computing one or more multiple lines of bearing (LOB) to a target device. The array of response data 242 can then be analyzed by the beam direction 218 module to identify an LOB to the target device.

FIG. 3 is an illustration of a motion command and response messages to communicate the user's intention over 60 GHz link to the target device in accordance with one possible embodiment of the invention. Further, FIG. 3 illustrates how a user 310 can use a hand held device (mobile device 150) to change the functionality of a first device such as AP or PCP 130 to a second device such as notebook PC 140 via motion language. Movement in a certain direction 320 in combination with beam direction can be translated, through motion language, as a command to change the functionality/role of the second device to be the master station for the wireless network. The hand held device then communicates 330 the information to the target device over the 60 GHz link in form of a command that is understood by both devices. The response 340 for the command with the result of the required action (either success or failure and potentially possible causes of failure) is then communicated back from the target device to the handheld device. The response is presented on the screen such as user interface 280 of the device to the user or by using an indicator on the target device indicating that the command has been implemented. In case of the failure in action the user may decide to repeat the process.

FIG. 4 is a flowchart illustrating a process 400 for generating a command from motion capture in accordance to an embodiment. Process 400 begins with action 410 where raw motion data is received at handheld device such as mobile device 150. As described above, the raw motion data may be received by any combination of accelerometers, gyros, cameras, or any other suitable motion detection components. At action 420, the raw motion data is processed to generate motion feature extraction indicative of the motion (translating along an axis) and the orientation (incline at a particular angle) of the device. The direction of motion of the device is determined from the motion and the orientation. Control is then passed to action 430 for further processing.

The mapping, action 430, of the actual direction of motion to a command may include accessing a motion command database 440, which may include user commands or possible commands stored in memory. For example, different users may have different mappings of motion to commands and different user commands. Thus, motion command database may also include user-specific mapping instructions or characteristics, user-created functions and any other function information which may be applicable to mapping a particular motion to one or more functions. User created commands could be acquired during a learning session where the user interacts with the device by providing a motion pattern in response to instructions displayed on the mobile device's screen. In action 450, the specific command from the direction of motion is ascertain and in action 460 the command is sent to the target device for processing. In FIG. 5 the specific command is correlated with beamforming information to better identify the target device.

FIG. 5 is a flowchart illustrating a process 500 to identify of a target device from the direction of motion and the direction of beam in accordance to an embodiment. Process 500 begins with action 510 with the capturing the direction of motion of network device such as mobile device 150. In action 520, beam direction utilized by the network device to communicate with the target device is ascertained. In action 530, correlation is performed on the direction of motion and the direction of beam. The direction information of the motion by the user is captured by the sensor (motion detection device 210) on the device and is associated with the beamforming information to identify the target device in action 540

FIG. 6 is a process diagram 600 illustrating how a command to dynamically assign network roles in a wireless network is communicated to a network device in accordance to an embodiment. A user through motion of a network device 605 (handheld device) generates a command 620 that when processed by a target device 610 causes the device to assume a particular role in the wireless network. The network device 605 sends the request 625 to the target device 610. The request 625 can be a command for the target device to assume a certain role, a request that a particular role be assigned to the handheld device, or a request inquiring about the role of the target device. The request is send to the target device for processing. At the target device, the received request is processed 630 by the target device and a response is prepared. The target device 610 communicates a response to the request 635. The response could be an indication that the target device 610 will assume the role, that the target device will assign the requested role to the network device 605, or a response to a request for status information such as the current role of the target device. At the network device 605 the response to the request is processed 640 and an indication is provided to the user in the form of a message on the display, an indication on the display, or a response requesting the network to acknowledge or approve the action to be taken by the target device. The network device 605 sends a response 645 with an acknowledgement, approval, cancel command, or a replacement command.

Embodiments within the scope of the present disclosure may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that performs particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Embodiments of the present invention provide a non-volatile computer readable medium encoded with computer executable instructions, which when accessed, cause a machine to allow input from the user so as to switch roles in a wireless network based on information from a user of the network device.

Although the above description may contain specific details, they should not be construed as limiting the claims in any way. Other configurations of the described embodiments of the disclosure are part of the scope of this disclosure. For example, the principles of the disclosure may be applied to each individual user where each user may individually deploy such a system. This enables each user to utilize the benefits of the disclosure even if any one of the large number of possible applications do not need the functionality described herein. In other words, there may be multiple instances of the components each processing the content in various possible ways. It does not necessarily need to be one system used by all end users. Accordingly, the appended claims and their legal equivalents should only define the disclosure, rather than any specific examples given.

We claim:

1. An apparatus to command via motion language a network device to dynamically assign network roles in a wireless network, comprising:
a motion based input device capable of enabling a user to command a network device to assign network roles to client stations in the wireless network.

2. The apparatus according to claim 1, wherein the motion language uses tractable movement to identify the command to the network device.

3. The apparatus according to claim 2, wherein the motion language uses tractable movement to identify a target client station.

4. The apparatus according to claim 3, wherein identifying the target client station is based on motion of the network device in the direction of the target client device.

5. The apparatus according to claim 4, wherein identifying the target client station is done through correlation of communication beam direction and the motion of the network device in the direction of the target client device.

6. The apparatus according to claim 4, wherein identifying the command to the network device is mapping the user's motion to possible commands defined a priori.

7. The apparatus according to claim 4, wherein the motion based input device is selected from a group including one or more accelerometers, gyros, inclinometers, cameras, tilt sensors, or any other sensors that can determine the motion of a device.

8. The apparatus according to claim 5, wherein communication beam direction is determined from beamforming information or ranging information, or a combination thereof.

9. A method to command via motion language a network device to dynamically assign network roles in a wireless network, comprising:
enabling a user through a motion based input device to command a network device to assign network roles to client stations in the wireless network.

10. The method according to claim 9, wherein the motion language uses tractable movement to identify the command to the network device.

11. The method according to claim 10, wherein the motion language uses tractable movement to identify a target client station.

12. The method according to claim 11, wherein identifying the target client station is based on motion of the network device in the direction of the target client device.

13. The method according to claim 12, wherein identifying the target client station is done through correlation of communication beam direction and the motion of the network device in the direction of the target client device.

14. The method according to claim 12, wherein identifying the command to the network device is mapping the user's motion to possible commands defined a priori.

15. The method according to claim 12, wherein the motion based input device is selected from a group including one or more accelerometers, gyros, inclinometers, cameras, tilt sensors, or any other sensors that can determine the motion of a device.

16. The method according to claim 13, wherein communication beam direction is determined from beamforming information or ranging information, or a combination thereof.

17. A machine-accessible medium that provides instructions, when executed by a machine, cause the machine to dynamically assign network roles in a wireless network comprising:
pre-storing at least one motion language command;
capturing through a motion based input device at least one motion to a network device to assign network roles to client stations in the wireless network during a recognition session; and
constructing a command from the motion captured during a recognition session and the pre-stored motion language command.

18. The machine-accessible medium according to claim 17, wherein the motion language uses tractable movement to identify the command to the network device.

19. The machine-accessible medium according to claim 18, wherein the motion language uses tractable movement to identify a target client station.

20. The machine-accessible medium according to claim 19, wherein identifying the target client station is based on motion of the network device in the direction of the target client device.

21. The machine-accessible medium according to claim 20, wherein identifying the target client station is done through correlation of communication beam direction and the motion of the network device in the direction of the target client device.

22. The machine-accessible medium according to claim 20, wherein identifying the command to the network device is mapping the user's motion to possible commands defined a priori.

23. The machine-accessible medium according to claim 20, wherein the motion based input device is selected from a group including one or more accelerometers, gyros, inclinometers, cameras, tilt sensors, or any other sensors that can determine the motion of a device.

24. The machine-accessible medium according to claim 21, wherein communication beam direction is determined from beamforming information or ranging information, or a combination thereof.
